(19) United States
(12) Patent Application Publication
(10) Pub. No.: US 2018/0176763 A1
(43) Pub. Date: Jun. 21, 2018

(54) MOBILE DEVICE AND METHOD FOR NETWORK PROFILE MANAGEMENT

(71) Applicant: SYMBOL TECHNOLOGIES, LLC, Lincolnshire, IL (US)

(72) Inventors: Souptick Joarder, Siliguri (IN); Janmejay Panda, Bangalore (IN); Sandeep Ramakrishnan, Bangalore (IN)

(21) Appl. No.: 15/381,284

(22) Filed: Dec. 16, 2016

(51) Int. Cl. H04W 8/18; H04M 1/725; H04W 48/16; H04W 76/02; H04W 4/02; H04W 48/14

(52) U.S. Cl. CPC H04W 8/18; H04M 1/72583; H04W 48/16; H04W 84/12; H04W 4/02; H04W 48/14; H04W 76/021

(57) ABSTRACT

A mobile device and method for network profile management is provided. An identifier of a network is received at the device. A time period is assigned to the identifier and the identifier and the time period are stored in association at a memory of the device. During the time period, the device: controls a communication interface to transmit the identifier of the network to scan for the network; and, when the network responds to transmission of the identifier, connects to the network using the communication interface. After the time period, the device: deletes the identifier and the time period from the memory; and stops transmitting the identifier when scanning for networks.

### BACKGROUND

When a device, such as a mobile device, detects a local network (such as a WiFi network), the device generally renders an identifier of the network at a display; when the identifier is selected, the identifier is stored in a memory. The device then periodically searches for the network by transmitting the identifier; for example, when the network is a WiFi network and the identifier is an SSID (service set identifier), the device periodically transmits the SSID in a WiFi probe request frame to search for the WiFi network, which uses processing resources, radio bandwidth, and battery resources. When the memory stores a plurality of such identifiers, the device periodically transmits each of the plurality of identifiers to search for respective networks (e.g. in a series of WiFi frames), which further increases use of processing resources, radio bandwidth, and battery resources. Indeed, as the number of identifiers stored at the memory increases, battery life can also decrease.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate implementations of concepts described herein, and explain various principles and advantages of those implementations.

FIG. 1 depicts a front perspective view of a device for network profile management, according to non-limiting implementations.

FIG. 2 depicts a schematic diagram of the device of FIG. 1, according to non-limiting implementations.

FIG. 3 depicts a block diagram of a method for network profile management, according to non-limiting implementations.

FIG. 4 depicts a system that includes the device of FIG. 1, according to non-limiting implementations.

FIG. 5 depicts the device of FIG. 1 providing a query for a time period to store a network identifier, according to non-limiting implementations.

FIG. 6 depicts the device of FIG. 2 storing a time period in association with a network identifier, according to non-limiting implementations.

FIG. 7 depicts the device of FIG. 1 scanning for networks during a stored time period, according to non-limiting implementations.

FIG. 8 depicts the device of FIG. 2 stopping scanning for networks after a time period has expired, according to non-limiting implementations.

FIG. 9 depicts the device of FIG. 2 storing a time period in association with a network identifier, the time period indicative that the identifier is to be permanently stored, according to non-limiting implementations.

FIG. 10 depicts the device of FIG. 1 providing a query to delete an identifier, according to non-limiting implementations.

FIG. 11 depicts the device of FIG. 2 deleting an identifier, according to non-limiting implementations.

FIG. 12 depicts the device of FIG. 2 temporarily storing an identifier to connected to a network, when a time period is indicative that the identifier is not to be stored, according to non-limiting implementations.

FIG. 13 depicts the device of FIG. 1 connecting to a network, when a time period is indicative that the identifier is not to be stored, according to non-limiting implementations.

FIG. 14 depicts the device of FIG. 1 rendering a query to set a global network save policy, according to non-limiting implementations.

FIG. 15 depicts the device of FIG. 2 implementing a global network save policy by storing override data, according to non-limiting implementations.

FIG. 16 depicts the device of FIG. 2 storing location data in association with a network identifier and a time period, according to non-limiting implementations.

FIG. 17 depicts the device of FIG. 1 transmitting an identifier only when at a stored location, according to non-limiting implementations.

FIG. 18 depicts the device of FIG. 2 storing location data in association with a network identifier, according to non-limiting implementations.

FIG. 19 depicts a block diagram of a method for network profile management, according to alternative non-limiting implementations

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present specification.

The apparatus and method components have been represented where appropriate by conventional symbols in the drawings, showing only those specific details that are pertinent to understanding the implementations of the present specification so as not to obscure the disclosure with details that will be readily apparent to those of ordinary skill in the art having the benefit of the description herein.

### DETAILED DESCRIPTION

A mobile device and method for network profile management is provided. An identifier of a network is received at the device. A time period is assigned to the identifier and the identifier and the time period are stored in association at a memory of the device. During the time period, the device: controls a communication interface to transmit the identifier of the network to scan for the network; and, when the network responds to transmission of the identifier, connects to the network using the communication interface. After the time period, the device: deletes the identifier and the time period from the memory; and stops transmitting the identifier when scanning for networks.

An aspect of the specification provides a mobile device comprising: a controller, a display, a memory and a communication interface configured to transmit existing identifiers of networks stored at the memory to scan for the networks, the controller configured to: receive, using the communication interface, an identifier of a new network not stored at the memory; control the display to render a first selectable option to store the identifier of the new network at the memory; when the first selectable option is selected, control the display to render a query for a time period to store the identifier; in response to the query: receive the time period to store the identifier, and store the identifier in association with the time period at the memory; during the time period: control the communication interface to transmit the identifier of the new network with the existing identifiers of the networks stored at the memory, to scan for the new network and the networks; and, when the new network responds to transmission of the identifier, connect to the new network using the communication interface; and, after the time period: delete the identifier and the time period from the memory; and stop transmitting the identifier when scanning for the networks.

In some example implementations, the device further comprises a location determining device, wherein the controller is further configured to: determine a location when the identifier of the new network is received; store the location at the memory in association with the identifier and the time period; and transmit the identifier of the new network with the existing identifiers of the networks stored at the memory, to scan for the new network and the networks, only when the location determining device indicates that a current location comprises the location stored with the identifier.

In some example implementations, the device further comprises a location determining device, wherein the controller is further configured to: determine a location when the identifier of the new network is received; when the time period is indicative that the identifier is to be permanently stored, store the identifier at the memory in association with the location and without the time period; and transmit the identifier of the new network with the existing identifiers of the networks stored at the memory, to scan for the new network and the networks, only when the location determining device indicates that a current location comprises the location stored with the identifier.

In some example implementations, each of the new network and the networks comprise WiFi networks, and each of the identifier and the existing identifiers comprise a respective SSID (Service Set Identifier) of each of the WiFi networks, and the controller is further configured to transmit the identifier of the new network with the existing identifiers of the networks stored at the memory by: transmitting the respective SSID of each of the WiFi networks in a respective probe request frame.

In some example implementations, the controller is further configured to, when the time period is indicative that the identifier is to be permanently stored: store the identifier at the memory without the time period; and delete the identifier from the memory only when a delete command for deleting the identifier is received at the controller.

In some example implementations, the controller is further configured to, when one or more of the first selectable option is not selected or the time period is indicative that the identifier is not to be stored: connect to the new network using the using the communication interface; and when the communication interface disconnects from the new network, delete the identifier from the memory.

In some example implementations, the controller is further configured to, when override data is stored at the memory: store the identifier at the memory without the time period; and delete the identifier only when a delete command, for deleting the identifier, is received.

In some example implementations, the controller is further configured to, when a global network save policy is compulsory: store the identifier at the memory without the time period; and delete the identifier only when a delete command, for deleting the identifier, is received.

In some example implementations, the controller is further configured to, in response to one or more of determining that the new network identified by the identifier is a hidden network, and determining that the identifier is part of a hidden profile: control the display to render the first selectable option using one or more of a menu, a pull-down menu and a graphic user interface rendered at the display.

Another aspect of the specification provides a method comprising: at a device comprising: a controller, a display, a memory and a communication interface configured to transmit existing identifiers of networks stored at the memory to scan for the networks, receiving, using the communication interface, an identifier of a new network not stored at the memory; controlling the display to render a first selectable option to store the identifier of the new network at the memory; when the first selectable option is selected, controlling the display to render a query for a time period to store the identifier; in response to the query: receiving the time period to store the identifier, and store the identifier in association with the time period at the memory; during the time period: controlling the communication interface to transmit the identifier of the new network with the existing identifiers of the networks stored at the memory, to scan for the new network and the networks; and, when the new network responds to transmission of the identifier, connect to the new network using the communication interface; and, after the time period: deleting the identifier and the time period from the memory; and stop transmitting the identifier when scanning for the networks.

In some example implementations, the device further comprises a location determining device, and the method further comprises: determining a location when the identifier of the new network is received; storing the location at the memory in association with the identifier and the time period; and transmitting the identifier of the new network with the existing identifiers of the networks stored at the memory, to scan for the new network and the networks, only when the location determining device indicates that a current location comprises the location stored with the identifier.

In some example implementations, the device further comprises a location determining device, and the method further comprises: determining a location when the identifier of the new network is received; when the time period is indicative that the identifier is to be permanently stored, storing the identifier at the memory in association with the location and without the time period; and transmitting the identifier of the new network with the existing identifiers of the networks stored at the memory, to scan for the new network and the networks, only when the location determining device indicates that a current location comprises the location stored with the identifier.

In some example implementations, the new network and the networks comprise WiFi networks, and each of the identifier and the existing identifiers comprise a respective SSID (Service Set Identifier) of each of the WiFi networks, and the method further comprises transmitting the identifier of the new network with the existing identifiers of the networks stored at the memory by: transmitting the respective SSID of each of the WiFi networks in a respective probe request frame.

In some example implementations, the time period is indicative that the identifier is to be permanently stored: storing the identifier at the memory without the time period; and deleting the identifier from the memory only when a delete command for deleting the identifier is received at the controller.

In some example implementations, the method further comprises, when one or more of the first selectable option is not selected or the time period is indicative that the identifier is not to be stored: connecting to the new network using the using the communication interface; and when the communication interface disconnects from the new network, delete the identifier from the memory.

In some example implementations, the method further comprises, when override data is stored at the memory: store the identifier at the memory without the time period; and delete the identifier only when a delete command, for deleting the identifier, is received.

In some example implementations, the method further comprises, when a global network save policy is compulsory: storing the identifier at the memory without the time period; and deleting the identifier only when a delete command, for deleting the identifier, is received.

In some example implementations, the method further comprises, in response to one or more of determining that the new network identified by the identifier is a hidden network, and determining that the identifier is part of a hidden profile: controlling the display to render the first selectable option using one or more of a menu, a pull-down menu and a graphic user interface rendered at the display.

Another aspect of the specification provides a computer-readable medium storing a computer program, wherein execution of the computer program is for: at a device comprising: a controller, a display, a memory and a communication interface configured to transmit existing identifiers of networks stored at the memory to scan for the networks, receiving, using the communication interface, an identifier of a new network not stored at the memory; controlling the display to render a first selectable option to store the identifier of the new network at the memory; when the first selectable option is selected, controlling the display to render a query for a time period to store the identifier; in response to the query: receiving the time period to store the identifier, and store the identifier in association with the time period at the memory; during the time period: controlling the communication interface to transmit the identifier of the new network with the existing identifiers of the networks stored at the memory, to scan for the new network and the networks; and, when the new network responds to transmission of the identifier, connect to the new network using the communication interface; and, after the time period: deleting the identifier and the time period from the memory; and stop transmitting the identifier when scanning for the networks. In some example implementations, computer-readable medium comprises a non-transitory computer-readable medium.

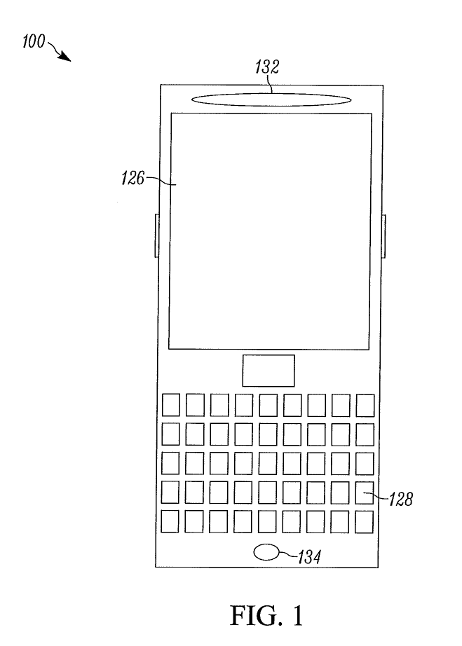

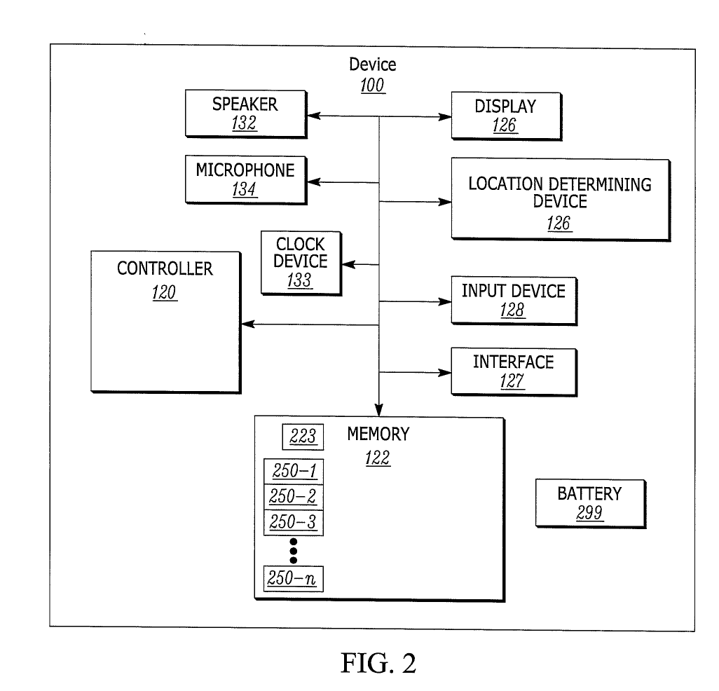

Attention is directed to FIG. 1, and FIG. 2 which respectively depict: a front perspective view of a mobile device 100 (interchangeably referred to hereafter as the device 100) with network profile management functionality; and a schematic diagram of the device 100. Device 100 comprises: a controller 120, a memory 122, a display 126, and a communication interface 127 (interchangeably referred to hereafter as the interface 127) configured to transmit existing identifiers of networks stored at the memory 122 to scan for the networks. The controller 120 is configured to: receive, using the communication interface 127, an identifier of a new network not stored at the memory 122; control the display 126 to render a first selectable option to store the identifier of the new network at the memory 122; when the first selectable option is selected, control the display 126 to render a query for a time period to store the identifier; in response to the query: receive the time period to store the identifier, and store the identifier in association with the time period at the memory 122; during the time period: control the communication interface 127 to transmit the identifier of the new network with the existing identifiers of the networks stored at the memory 122, to scan for the new network and the networks; and, when the new network responds to transmission of the identifier, connect to the new network using the communication interface 127; and, after the time period: delete the identifier and the time period from the memory 122; and stop transmitting the identifier when scanning for the networks.

As depicted, the device 100 further comprises an input device 128, a location determining device 130, and a clock device 133.

While not depicted, in some implementations, the device 100 further includes one or more of an orientation sensor, a data capture component, a scanner, a camera, a light, a light emitting diode (LED), a haptic device, a notification device, a push-to-talk (PTT) device, as well as any other components used in mobile devices.

Indeed, the device 100 generally comprises a mobile device which includes, but is not limited to, any suitable combination of electronic devices, communications devices, computing devices, portable electronic devices, mobile computing devices, portable computing devices, tablet computing devices, telephones, PDAs (personal digital assistants), cellphones, smartphones, e-readers, mobile camera devices and the like. Other suitable devices are within the scope of present implementations. For example, while as depicted the device 100 is a mobile communication device with telephonic functionality, the device 100 need not comprise a mobile communication device, but rather, in other implementations, comprises a device specifically adapted for specialized functionality. In some implementations, the device 100 is specifically adapted for warehouse inventory tracking and/or other data acquisition functionality using a data capture component, and the like; in some of these implementations, the device 100 further includes other types of hardware for warehouse inventory tracking and/or other data acquisition functionality, including, but not limited to, one or more of a radio frequency identification (RFID) reader, a Near Field Communication (NFC) reader, and/or other types of data acquisition components. In yet further implementations, the device 100 is mountable in a vehicle. However, other devices are within the scope of present implementations.

The example controller 120 of FIG. 2 includes one or more logic circuits configured to, for example, implement network management functionality of the device 100. Example logic circuits include one or more processors, one or more microprocessors, one or more ASIC (application-specific integrated circuits) and one or more FPGA (field-programmable gate arrays). In some examples, the device 100 is not a generic computing device, but a mobile device specifically configured to implement specific network management functionality. For example, in some implementations, the device 100 and/or the controller 120 specifically comprises a computer executable engine configured to implement specific network management functionality.

The memory 122 of FIG. 2 is a machine readable medium that stores machine readable instructions to implement one or more programs or applications. Example machine readable media include a non-volatile storage unit (e.g. Erasable Electronic Programmable Read Only Memory (“EEPROM”), Flash Memory) and/or a volatile storage unit (e.g. random access memory (“RAM”)). In the example of FIG. 2, programming instructions (e.g., machine readable instructions) that implement the functional teachings of the device 100 as described herein are maintained, persistently, at the memory 122 and used by the controller 120 which makes appropriate utilization of volatile storage during the execution of such programming instructions.

The example memory 122 of FIG. 2 stores instructions corresponding to an application 223 that, when executed by the controller 120, enables the controller 120 to implement network management functionality associated with the application 223. In the illustrated example, when the controller 120 executes the application 223, the controller 120: receives, using the communication interface 127, an identifier of a new network not stored at the memory 122; controls the display 126 to render a first selectable option to store the identifier of the new network at the memory 122; when the first selectable option is selected, controls the display 126 to render a query for a time period to store the identifier; in response to the query: receives the time period to store the identifier, and stores the identifier in association with the time period at the memory 122; during the time period: controls the communication interface 127 to transmit the identifier of the new network with the existing identifiers of the networks stored at the memory 122, to scan for the new network; and, when the new network responds to transmission of the identifier, connects to the new network using the communication interface 127; and, after the time period: deletes the identifier and the time period from the memory 122; and stops transmitting the identifier when scanning for the networks. In some implementations, application 223 corresponds to a network save policy, which defines how long identifiers of networks are saved.

FIG. 2 further depicts the example memory 122 storing identifiers 250-1, 250-2, 250-3 . . . 250-n. The identifiers 250-1, 250-2, 250-3 . . . 250-n will be interchangeably referred to hereafter, collectively, as the identifiers 250 and, generically, as an identifier 250. Each of the identifiers 250 comprises an identifier of a network that the device 100 is configured to search for using the interface 127. In some implementations, each of the identifiers 250 comprises an identifier of a network that the device 100 has previously communicated with and hence has received a respective identifier 250 from a respective network, and then stored the respective identifier 250 at the memory 122. In a particular example implementation, each of the identifiers 250 comprises a WiFi Service Set Identifier (SSID) of a WiFi network and/or access point that device 100 has previously encountered and/or an SSID of a WiFi network received at device 100 for storage, for example by another device. Regardless, the device 100 and/or the controller 120 controls the interface 127 to periodically transmit the existing identifiers 250 stored at the memory 122, to scan for the networks identified by the identifiers 250; for example, in some of these implementations, each of the existing identifiers 250 are transmitted in a respective WiFi probe request frame; in some of these implementations, each of the existing identifiers 250 are transmitted in a respective WiFi probe request frame in a sequence corresponding, for example, to an order that the identifiers 250 are stored at the memory 122, or based on another criteria, such as an alphanumeric order, and the like.

While the example memory 122 of FIG. 2 stores “n” identifiers 250, a number of the identifiers 250 depends on a number of networks that have previously been encountered and/or a number of the identifiers 250 that have been provisioned at the memory 122 by another device. Indeed, in some implementations, the number of the identifiers 250 is initially “0”.

While not depicted, in some implementations, each of the identifiers 250 are stored at the memory 122 with passwords of associated networks, used to log-in, and/or automatically log-in, to the associated network when the associated network responds to a transmission of an identifier 250. Hence, in some example implementations, each of the identifiers 250 comprises a respective set of network credentials and/or network profiles and/or WiFi credentials and/or WiFi profiles. Hence, in some implementations, each of the identifiers 250 comprises other associated network information which includes, but is not limited to one or more of an SSID, location information, a type of security associated with the network, whether the network has a hidden profile, and the like. For example, some of these implementations, at least some of the WiFi credentials are collected by the device 100 as the device 100 is transported to the vicinity of different WiFi networks, including, but not limited to, WiFi networks in airports, coffee shops, public spaces, different work environments, people's homes, and the like.

The example display 126 of FIG. 2 comprises any suitable one of, or combination of, flat panel displays (e.g. LCD (liquid crystal display), plasma displays, OLED (organic light emitting diode) displays) and the like, as well as one or more optional touch screens (including capacitive touchscreens and/or resistive touchscreens.

The example interface 127 of FIG. 2, which is implemented by, for example, one or more radios and/or connectors and/or network adaptors, is configured to communicate wired and/or wirelessly with network architecture that is used to implement one or more communication links between other devices and/or a network. Example communication links include one or more of USB (universal serial bus) cables, serial cables, wireless links, cell-phone links, cellular network links (including but not limited to 2G, 2.5G, 3G, 4G+ such as UMTS (Universal Mobile Telecommunications System), GSM (Global System for Mobile Communications), CDMA (Code division multiple access), FDD (frequency division duplexing), LTE (Long Term Evolution), TDD (time division duplexing), TDD-LTE (TDD-Long Term Evolution), TD-SCDMA (Time Division Synchronous Code Division Multiple Access) and the like), wireless data, WLAN (wireless local area network) links, WiFi links, WiMax links, packet based links, the Internet, analog networks, the PSTN (public switched telephone network), access points, and the like, and/or a combination.

The example input device 128 of FIG. 2, includes, but is not limited to, a keyboard, a touch screen of the display 126, a touch pad, one or more buttons, one or more actuators, and the like.

The example location determining device 130 of FIG. 2 includes, but is not limited to a Global Positioning System (GPS) device, a GLONASS (Global Navigation Satellite System) device, a triangulation device, and the like. In particular, the location determining device 130 determines a location of the device 100, a relative location of the device 100 and/or an absolute location of the device 100.

The example clock device 133 of FIG. 2 is configured to determine a time and/or a current time; however, while the clock device 133 is depicted as a distinct component in the device 100, in other implementations, the clock device 133 is a component of another component of the device 100. For example, in some implementations, the clock device 133 is a component of controller 120 including, but not limited to, a clock in a processor and/or a logic circuit of the controller 120,

As depicted, the example device 100 of FIG. 2 includes a battery 299 that includes, but is not limited to, a rechargeable battery, a power pack, and/or a rechargeable power pack. The example battery 299, powers components of the device 100, such that the device 100 is portable without connection to a mains power supply. In some examples, the device 100 includes a connection to a mains power supply and/or a power adaptor (e.g. an AC-to-DC (alternating current to direct current) adaptor) configured to charge the example battery 299. In some implementations, the example battery 299 of the device 100 is configured to charge in a charging cradle and/or wirelessly. In some implementations, the example battery 299 of the device 100 is configured for quick charging, for example using inductive charging.

In particular, the process of the device 100 and/or the controller 120 controlling the interface 127 to transmit the identifiers 250 uses power of the battery 299 and, in some implementations, contributes to the life of the battery 299 being diminished and/or shortened.

The example device 100 may include additional or alternative components related to, for example, telephony, messaging, entertainment, and/or any other components that may be used with a mobile device.

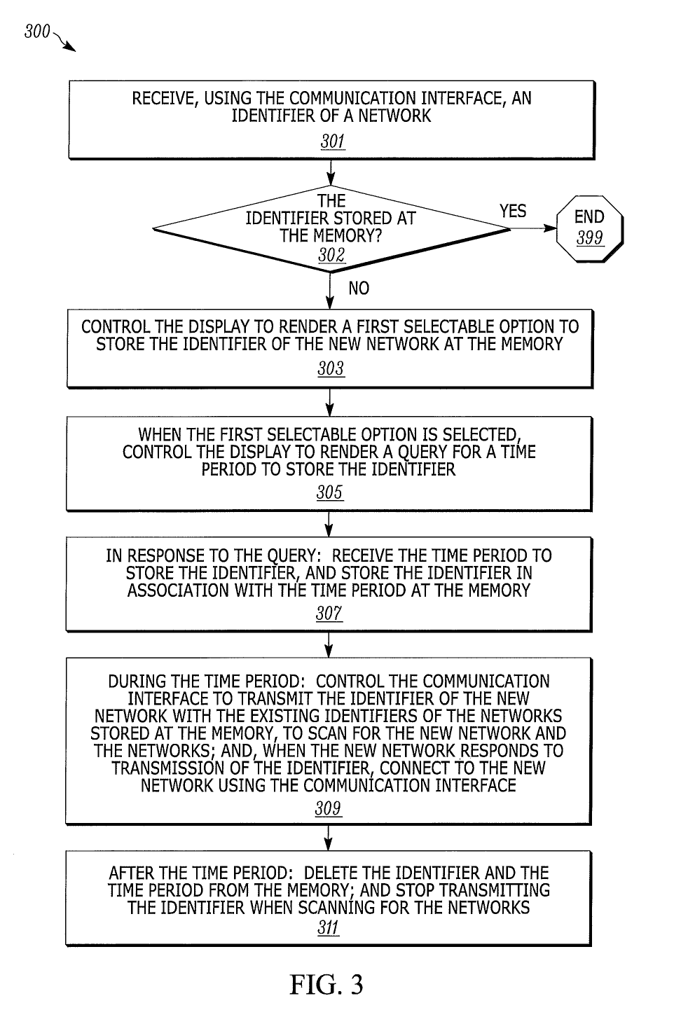

Attention is now directed to FIG. 3 which depicts a flowchart representative of an example method 300 for network profile management of the example device 100 of FIG. 2. The example operations of the method 300 of FIG. 3 correspond to machine readable instructions that are executed by, for example, the device 100 of FIG. 2, and specifically by the controller 120 of the device 100. In the illustrated example, the instructions represented by the blocks of FIG. 3 are stored at the memory 122, for example, as the application 223. The example method 300 of FIG. 3 is one way in which the device 100 may be configured. Furthermore, the following discussion of the example method 300 of FIG. 3 will lead to a further understanding of the device 100, and its various components. However, it is to be understood that the device 100 and/or the method 300 may be varied, and need not work exactly as discussed herein in conjunction with each other, and that such variations are within the scope of present implementations.

The example method 300 of FIG. 3 need not be performed in the exact sequence as shown and likewise various blocks may be performed in parallel rather than in sequence. Accordingly, the elements of method 300 are referred to herein as “blocks” rather than “steps.” The example method 300 of FIG. 3 may be implemented on variations of the example device 100 of FIG. 2, as well.

At block 301, the controller 120 receives, using the communication interface 127, an identifier of a network, such as an SSID, and at block 302 checks whether the identifier received at the block 301 is already stored at the memory 122. When the identifier received at the block 301 is already stored at the memory 122 (e.g. a “Yes” decision at the block 302), the method 300 ends at a block 399. However, when the identifier received at the block 301 is not stored at the memory 122 (e.g. a “No” decision at the block 302), then the network is new and the method proceeds to block 303.

At block 303, the controller 120 controls the display 126 to render a first selectable option to store the identifier of the new network at the memory 122.

At block 305, the controller 120, when the first selectable option is selected, controls the display 126 to render a query for a time period to store the identifier.

At block 307, the controller 120, in response to the query: receives the time period to store the identifier; and stores the identifier in association with the time period at the memory 122.

At block 309, the controller 120, during the time period: controls the communication interface 127 to transmit the identifier of the new network with the existing identifiers 250 of the networks stored at the memory 122, to scan for the new network and the previously stored networks; and, when the new network responds to transmission of the identifier, connects to the new network using the communication interface 127.

At block 311, the controller 120, after the time period: deletes the identifier and the time period from the memory 122; and stops transmitting the identifier when scanning for the networks.

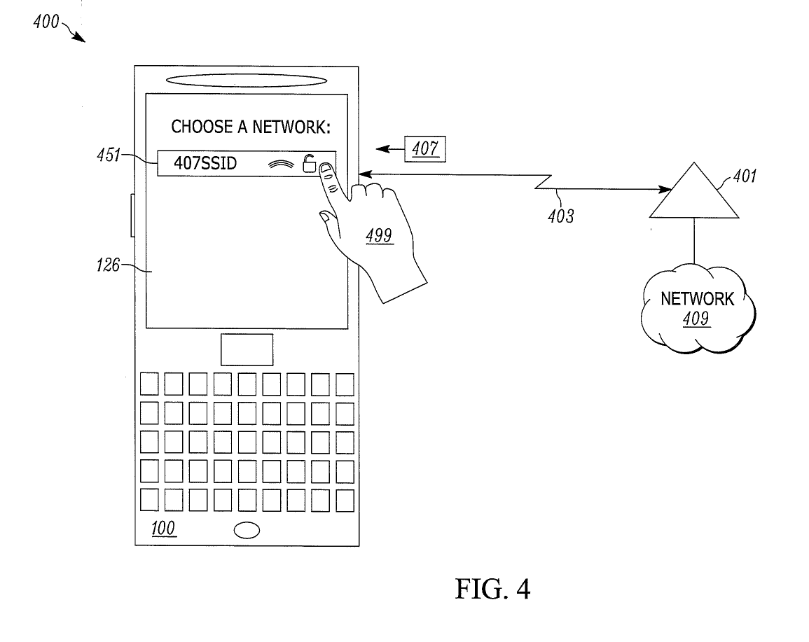

Method 300 will now be described with reference to FIG. 4 to FIG. 18.

Attention is next directed to FIG. 4 which depicts a system 400 that includes the device 100 and an access point 401. In the example of FIG. 4, the access point 401 comprises a WiFi access point in communication with the device 100 using a wireless communication link 403 established using a radio of the interface 127. The access point 401 transmits an identifier 407 to the device 100, for example, using the link 403. In some implementations, the access point 401 broadcasts the identifier 407. In other implementations, the access point 401 transmits the identifier 407 to the device 100 upon receiving a request for network identifiers broadcast by the device 100. In an example implementation, the identifier 407 comprises a WiFi Service Set Identifier (SSID) of a network 409 to which the access point 401 provides access. Hence, FIG. 4 represents an example implementation of the block 301 of the method 300.

In the example of FIG. 4, it is assumed that the identifier 407 comprises an SSID that includes alphanumeric text “407SSID”; in other words, the network 409 is identified by an SSID that includes alphanumeric text “407SSID”. FIG. 4 further depicts the device 100 and/or the controller 120 controlling the display 126 to render a first selectable option 451 to store, at the memory 122, the identifier 407 of the new example network 409. The example first selectable option 451 comprises a virtual button rendered at the display 126 with the alphanumeric text “407SSID” received with the identifier 407, as well as an icon indicative of the signal strength of the new network 409, and an icon indicative of whether the new network 409 requires a password for access (as depicted, the new network 409 does not require a password, and the associated icon includes a pictograph of an open lock).

Hence, FIG. 4 further represents an example implementation of the block 303 of the method 300.

In the example of FIG. 4, the example first selectable option 451 is depicted as being selected by receipt of touch input at the display 126, assuming that the example display 126 includes a touch screen, and the touch input is being received by way of a finger of a hand 499 touching the example display 126. Hence, FIG. 4 further partially represents an example implementation of the block 305 of the method 300. However, in other implementations, the first selectable option 451 is selectable using input device 128, and the like. Indeed, while present implementations are described with respect to options, queries, menus, virtual buttons and the like being selected using a touch screen, any process for selecting queries, menus, virtual buttons and the like rendered at display 126 is within the scope of present implementations.

In further example implementations, the first selectable option 451 is provided using one or more of a menu, a pull-down menu, a GUI (Graphic User Interface) and the like. For example, in some example implementations, the identifier 407 is an identifier of a hidden network and/or a hidden WiFi network, and hence the device 100 does not automatically provide the first selectable option 451 when the identifier 407 is received; rather, in some of these implementations, one or more of a menu, a pull-down menu, a GUI and the like is used to navigate to an “Add Network” input page and/or an “Add Profile” input page, and a prompt is provided to add a network and/or a network profile, and the a selectable option is provided to one or more receive the identifier 407 as input (e.g. as a SSID) and receive a name of a network associated with the identifier 407 to cause the identifier 407 to be provided and stored at the memory 122. For example, when the network 409 comprises a WiFi network, and the device 100 includes an implementation of an Android operating system, a menu system is provided with a sequence “Go to Settings->Wifi->Add network” to add a WiFi network. Such implementations are within the scope of the present specification.

Hence, similar to the identifiers 205, in some implementations, the identifier 407 comprises a set of network credentials and/or a network profile and/or WiFi credentials and/or a WiFi profile, for example for the network 409. Hence, in some implementations, the identifier 407 comprises other associated network information which includes, but is not limited to one or more of an SSID, location information, a type of security associated with the network 409, whether the network 409 has a hidden profile, and the like.

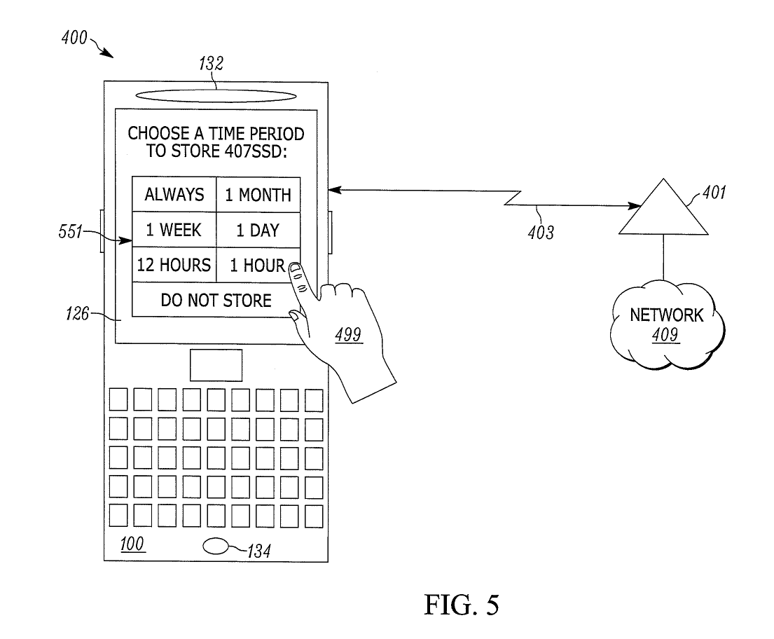

Attention is next directed to FIG. 5 which depicts the system 400 when the controller 120 is implementing the block 305 of the method 300, assuming that the first selectable option 451 has been selected as describe above. In particular, the device 100 and/or the controller 120, when the first selectable option is selected, controls the display 126 to render a query 551 for a time period to store the identifier 407. The example, the query 551 of FIG. 5 comprises a plurality of virtual buttons, each corresponding to a possible time periods for storing the identifier 407, for example “Do Not Store” (as described in further detail below), “1 Hour”, “12 Hours”, “1 Day”, “1 Week”, “1 Month” and “Always” (as described in further detail below). However, in other implementations, the query 551 comprises one or more of a menu, a pull-down menu, a text-editing box, and the like, used to indicate a time period for storage of the identifier 407. In yet further implementations, the query 551 comprises an aural query (e.g. using a text to voice engine, and the like) using speaker 132 and the time period is selected via a voice command using microphone 134.

Furthermore, while the time periods of the query 551 are defined in terms of a time from a selection thereof, in other implementations, the time periods are defined with respect to other types of time periods; for example, in some implementations another time period includes “STORE UNTIL DISCONNECT”, associated with functionality similar to the functionality implemented when the “Do Not Store” option is selected, as described below.

In the example implementation of FIG. 5, a time period is selected by receipt of touch input at the display 126, assuming that the example display 126 includes a touch screen, and the touch input is being received by way of a finger of the hand 499 touching the example display 126. In particular, the finger of the hand 499 is selecting a time period of “1 Hour” by touching the corresponding virtual button.

Regardless, FIG. 5 depicts the device 100 and/or the controller 120, in response to the query: receiving the time period to store the identifier 407. Hence, FIG. 5 further partially represents an example implementation of the block 307 of the method 300.

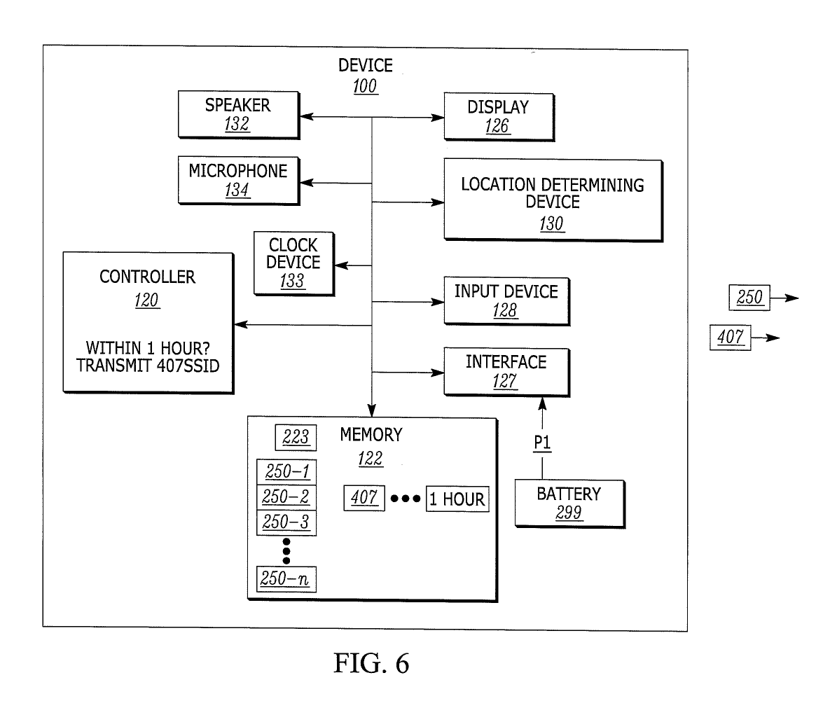

Attention is next directed to FIG. 6, which is substantially similar to FIG. 2, with like elements having like numbers. In FIG. 6, it is assumed that a time period of “1 Hour” has been selected at the block 307 of the method 300 and stored at the memory 122 in association with the identifier 407. Hence, FIG. 6 further partially represents an example implementation of the block 307 of the method 300.

However, while the present example is described with respect to the time period of “1 Hour” being selected, present implementations proceed according to any time period received at the block 307 of the method 300.

In the example implementation of FIG. 6, the controller 120 is depicted as further determining whether a time period corresponding to the stored time period associated with the identifier 407 has passed and/or whether a current time is within the stored time period associated with the identifier 407. For example, once the time period of 1 hour (and the like) has been stored, the controller 120 determines whether the time period has passed using clock device 133, and the like.

As also depicted in the example of FIG. 6, the controller 120 is determining that the time period of 1 hour has not passed. Specifically, during the time period, the device 100 and/or controller 120: controls the communication interface 127 to transmit the identifier 407 of the new network with the existing identifiers 250 of the networks stored at the memory 122, to scan for the new network and the networks; and, when the new network responds to transmission of the identifier 407, connects to the new network using the communication interface 127. Hence, FIG. 6 further represents an example implementation of the block 309 of the method 300.

Furthermore, the battery 299 provides a power P1 to the interface 127 to transmit the identifiers 250, 407.

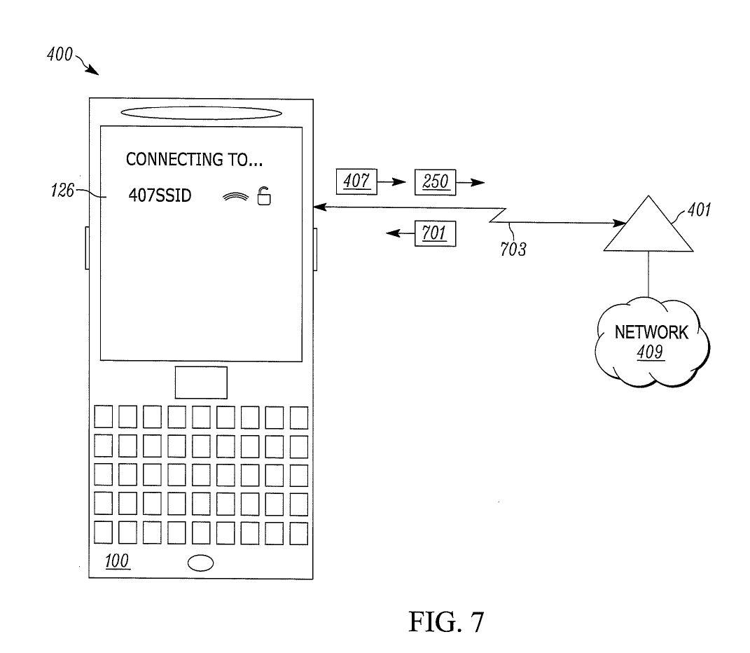

Attention is next directed to FIG. 7 which further depicts an example implementation of the block 309 of the method 300. In particular, in the example, implementation of FIG. 7 it is assumed that the device 100 has stored the identifier 407 in association with a time period, as described above, and is in the process of transmitting identifiers 250, 407 to scan for networks.

Further, in the example implementation of FIG. 7 it is assumed that device 100 has left a vicinity of access point 401 and then returned to a vicinity of access point 401. As such, device 100 transmits identifiers 250, 407, for example in respective WiFi probe request frames (e.g. independent of location), to scan for networks identified by identifiers 250, 407 stored at the memory 122. When the access point 401 receives each of the identifiers 250, the access point 401 does not respond; however, when the access point 401 receives the identifier 407, the access point 401 transmits a response 701 to the device 100 to set up a communication link 703 between the device 100 and the access point 401 and network 409, such that the device 100 has access to the network 409 via the communication link 703. It is further understood that any passwords stored at the memory 122 with the identifier 407 are used to log-in to the access point 401 and/or the network 409.

Again assuming that the access point 401 comprises a WiFi access point, and each of new network 409 and the networks identified by the identifiers 250 comprise WiFi networks, and again assuming that each of the identifier 407 and the existing identifiers250 comprise a respective SSID of each of the WiFi networks, in the example implementation of FIG. 7, the controller 120 is further configured to transmit the identifier 407 of the new network with the existing identifiers 250 of the networks stored at the memory 122 by: transmitting the respective SSID of each of the WiFi networks in a respective probe request frame. In other words, in FIG. 7, the identifiers 250, 407 are each transmitted in a respective probe request frame.

As also depicted in the example implementation of FIG. 7, the device 100 and/or the controller 120 renders a GUI at display 126 to indicate that device 100 is connecting to a network identified by an SSID “407SSID”.

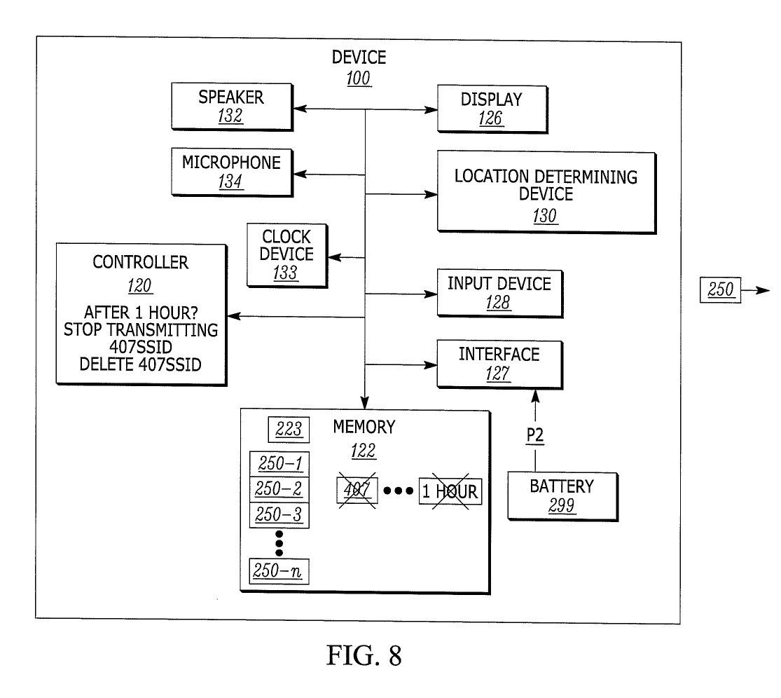

Attention is next directed to FIG. 8, which is substantially similar to FIG. 7, with like elements having like numbers. Furthermore, FIG. 8 depicts an example implementation of the block 311 of the method 300. It is assumed in the example of FIG. 8 that the time period stored in association with the identifier 407 has passed. Hence, the device 100 and/or the controller 120 deletes the identifier 407 and the time period of 1 hour from the memory 122 and stops transmitting the identifier 407 when scanning for networks. For example, as depicted, as the identifiers 250 are stored without time periods, when scanning for networks, the device 100 and/or the controller 120 continues to transmit the identifiers 250. Hence, as depicted in the example of FIG. 8, after the time period, the device 100 and/or the controller 120: deletes the identifier 407 and the time period from the memory 122; and stops transmitting the identifier 407 when scanning for networks.

Furthermore, the battery 299 provides a power P2 to the interface 127 to transmit the identifiers 250 when scanning for networks. In general, the power P2 is less than the power P1 used to transmit the identifiers 250, 407. Hence, by deleting the identifier 407 after the associated time period, an amount of power used to scan for networks is reduced, which generally increases battery life, and a life of operation of device 100 using a fully charged battery 299.

Indeed, further power savings can be provided when one or more of the identifiers 250 is stored in association with a respective time period, and the blocks 309, 311 implemented for each of the identifiers 250 that are stored in association with a respective time period.

Implementation of the embodiments of the method 300, as described in the present disclosure, results in a significant impact on extending the battery life of the device. In one exemplary implementation, the method 300 results in approximately 7-8% improvement in battery life of the device 100 over a 12 hour time period.

Indeed, considering situations where a device is transported through a plurality of airports, coffee shops, and the like, and is used to log into many WiFi networks, adding an expiry time to each set of WiFi identifiers and/or WiFi credentials can save significant battery life, as otherwise the device would continue to scan for those networks regardless of whether the device was going to be transported back to the same airports, coffee shops, and the like.

Returning briefly to FIG. 5, the query 551 also includes two selectable options “Do Not Store” and “Always”, which will be described hereafter.

In particular, “Always” corresponds to a time period indicative that the identifier 407 is to be permanently stored. As such, in these example implementations, the device 100 and/or the controller 120: stores the identifier 407 at the memory 122 without the time period (and/or a time period indicative “infinity”); and deletes the identifier 407 from the memory 122 only when a delete command for deleting the identifier 407 is received at the controller 120.

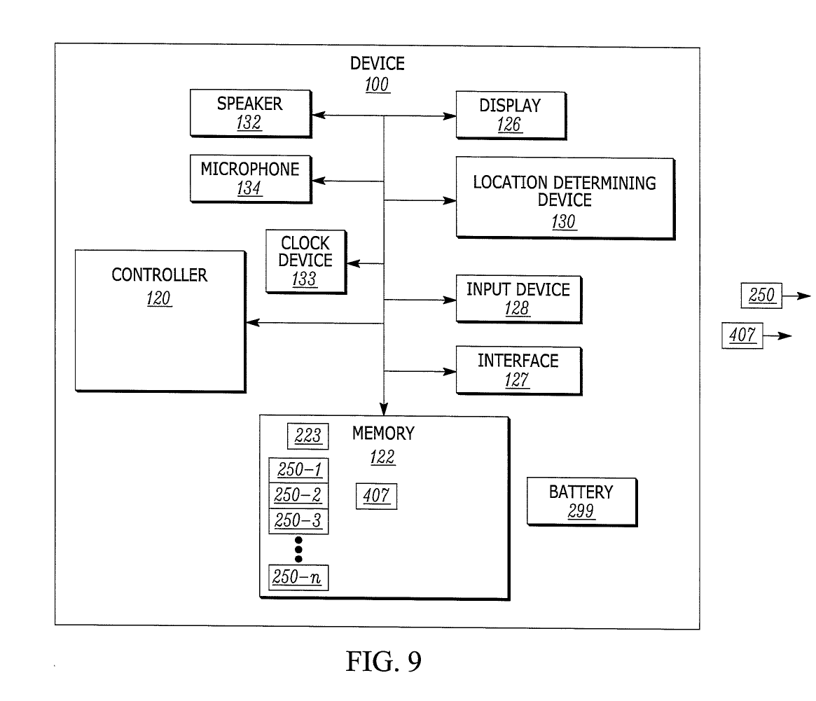

For example, attention is directed to FIG. 9, which is substantially similar to FIG. 6, with like elements having like numbers; however, in FIG. 9, it is assumed that “Always” was selected in the example of FIG. 5, and hence the identifier 407 is stored at the memory 122 without an associated time period, and the interface 127 periodically scans for networks using identifiers 250, 407 until a delete command for deleting the identifier 407 is received at the controller 120.

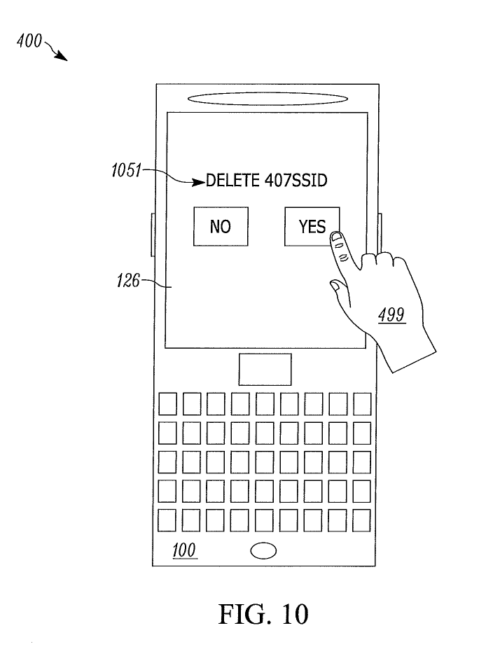

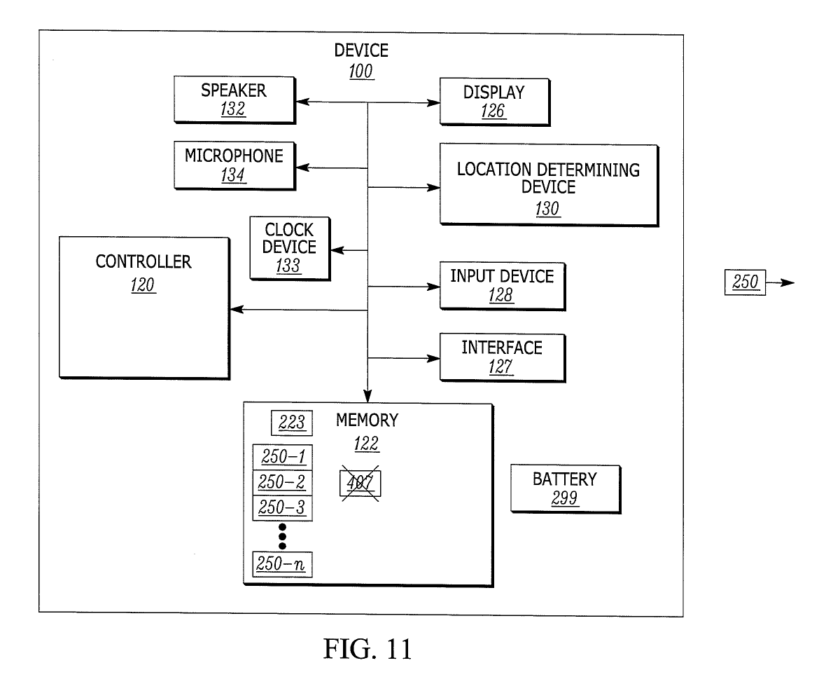

For example, attention is next directed to FIG. 10, which is substantially similar to FIG. 1, with like elements having like numbers; however, in the example of FIG. 10, the device 100 and/or the controller 120 is controlling the display 126 to render a query 1051 to delete the identifier 407, along with selectable options of “YES” and “NO”. In some example implementations, the query 1051 is rendered at the display 126 by way of a menu system and/or GUI at the device 100; for example, the finger of the hand 499 is used to interact with the menu system and/or GUI to select the identifier 407 from a list of the identifiers 250, 407, along with an option to delete the identifiers 250, 407. The option to delete the identifiers 250, 407 includes an option to delete respective identifiers 250, 407, including the query 1051. Assuming that the selectable option “YES” is selected, the identifier 407 is deleted from the memory 122, as depicted in FIG. 11 (substantially similar to FIG. 9, with like elements having like numbers), and the interfaces stops transmitting the identifier 407. Hence, in these example implementations, the controller 120 is further configured to: when the time period (e.g. as received in the example of FIG. 5) is indicative that the identifier 407 is to be permanently stored, store the identifier 407 at the memory 122 without the time period; and delete the identifier from the memory 122 only when a delete command (e.g. the “YES” option of the example of FIG. 10) for deleting the identifier is received at the controller 120.

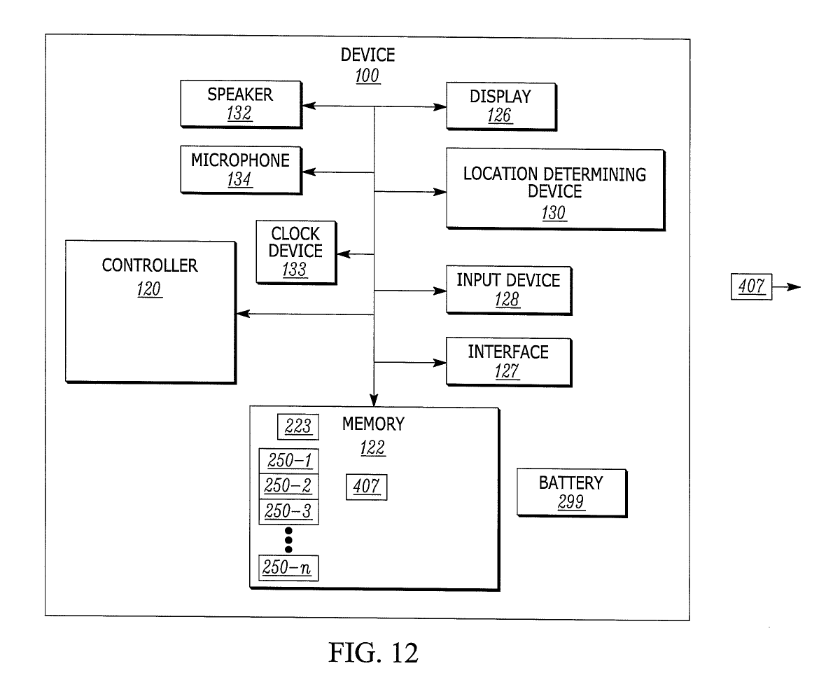

For example, attention is directed to FIG. 12, which is substantially similar to FIG. 6, with like elements having like numbers; however, in FIG. 12, it is assumed that “Do Not Store” was selected in the example of FIG. 5, and hence the identifier 407 is only temporarily stored at the memory 122 for example until the interface 127 connects with the associated network 409; however, the interface 127 attempts to connect to the associated network 409, as in FIG. 7, however without necessarily scanning for networks identified by the identifiers 250.

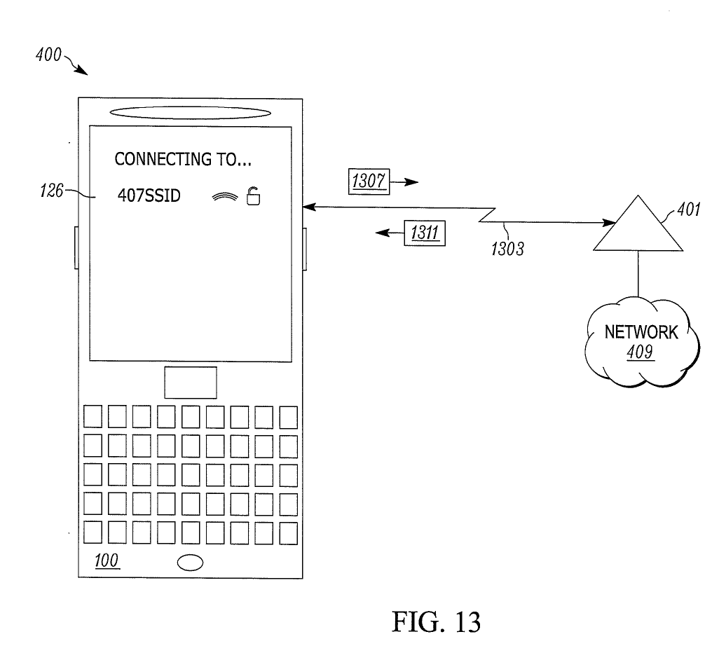

For example, attention is next directed to FIG. 13, which is substantially similar to FIG. 5, with like elements having like numbers; however, in the example of FIG. 13, the device 100 and/or the controller 120 has received the identifier 407, and the selectable option “Do Not Store” was selected in the example of FIG. 5. Hence, the identifier 407 is temporarily stored at the memory 122 such that the device 100 nonetheless establishes a communication link 1303 with the access point 401, for example, by exchanging connection data 1307, 1311 with the access point 401. When the device 100 and/or the interface 127 later disconnects from the access point 401 and/or the new network 409, the identifier 407 is deleted from the memory 122, similar to the example of FIG. 11.

With brief reference to FIG. 4, in yet further example implementations, first selectable option 451 is not selected; instead, after a time period (e.g. a few seconds, as configured in application 223, for example), the example implementation of FIG. 12 and FIG. 13 is implemented without the display 126 rendering the example query 551 of FIG. 5. In these implementations, the connection to access point 401 occurs automatically, assuming that the time period is indicative that the identifier 407 is not to be stored.

In other words, in some implementations, the controller 120 is further configured to, when one or more of the first selectable option 451 is not selected and the time period (e.g. selected via the query 551) is indicative that the identifier 407 is not to be stored: connect to the new network 409 using the using the communication interface 127; and when the communication interface 127 disconnects from the new network 409, delete the identifier 407 from the memory 122.

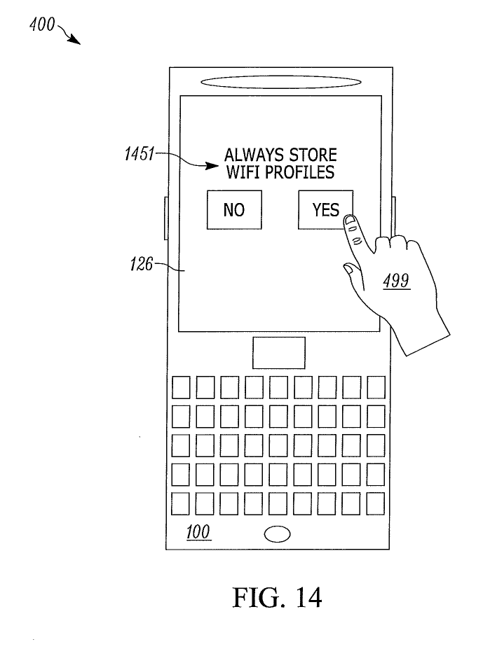

In some example implementations, the method 300 is only implemented when a global network save policy is not compulsory. For example, attention is next directed to FIG. 14, which is substantially similar to FIG. 1, with like elements having like numbers; however, in the example of FIG. 14, the device 100 and/or the controller 120 is controlling the display 126 to render a query 1451 to set a global network save policy, which can be interchangeably referred to as an override option (e.g. to override method 300).

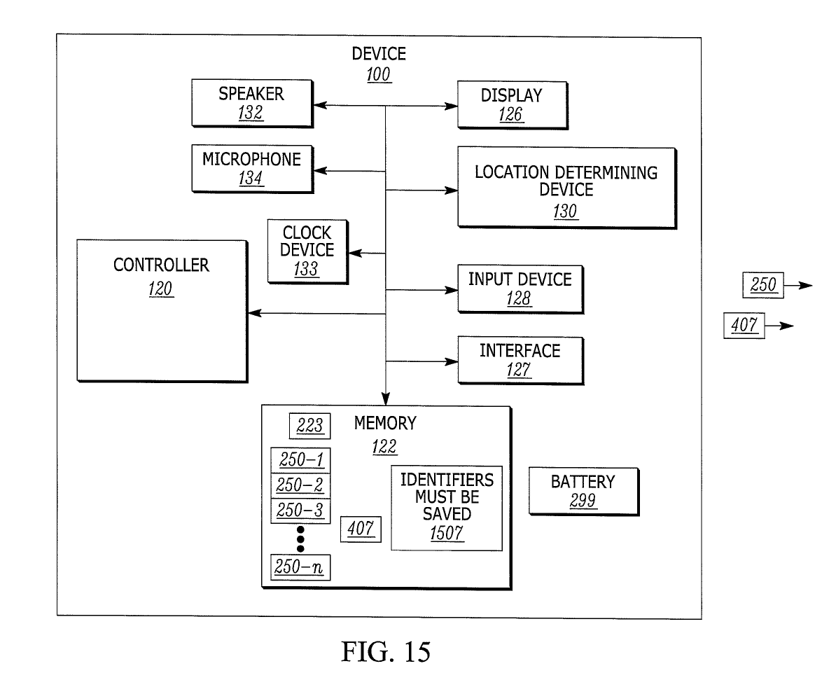

In some example implementations, the query 1451 is rendered at the display 126 by way of a menu system and/or GUI at the device 100; for example, the finger of the hand 499 is used to interact with the menu system and/or GUI to navigate to the query 1451. The query 1451 queries whether WiFi profiles, and the like, should always be stored (e.g. without a time period), along with selectable options “YES” and “NO” to set (or not) the global network save policy and/or override option as being compulsory. When the “YES” option is selected, method 300 is not implemented. Furthermore, with reference to FIG. 15 (substantially similar to FIG. 6, with like elements having like numbers) override data 1507 is stored at the memory 122 indicative that identifiers 250, 407 are not to be deleted until a delete command is received (e.g. as depicted in the example of FIG. 10). While the override data 1507 is depicted a textual rule stored at the memory 122, the override data 1507 is of any format compatible with indicating that identifiers 250, 407 are not to be deleted until a delete command is received, including, but not limited to, a data flag and the like.

Put another way, in these example implementations, the controller 120 is further configured to: when the override data 1507 is stored at the memory 122, store the identifier 407 at the memory 122 without the time period; and delete the identifier 407 only when a delete command, for deleting the identifier 407, is received.

One of ordinary skill in the art appreciates that various modifications and changes can be made without departing from the scope of the specification. For example, in some implementations, the device 100 and/or the method 300 is adapted to transmit the identifier 407 (and the like) based on location.

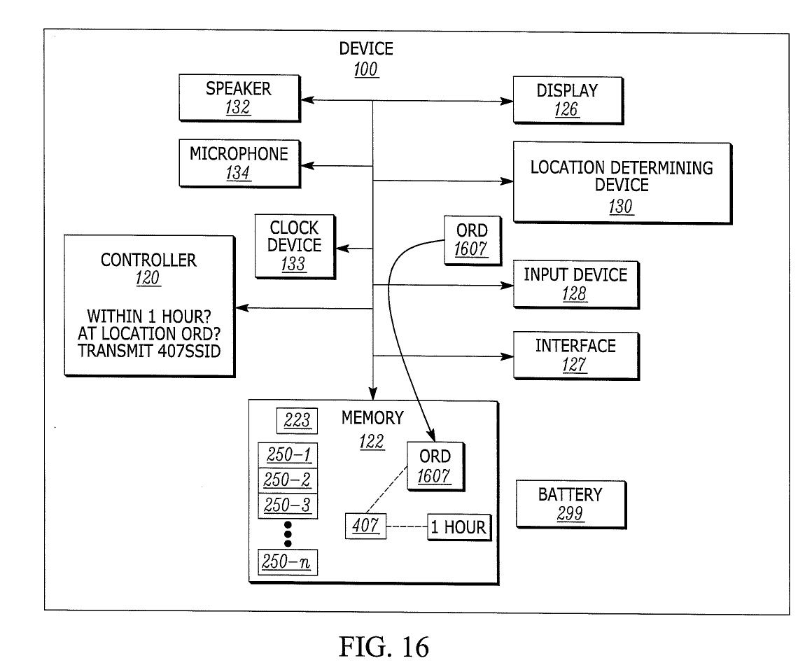

Hence, attention is next directed to FIG. 16, which is substantially similar to FIG. 5, with like elements having like numbers. However, in the example of FIG. 16, when the identifier 407 is stored in association with the time period “1 Hour” (or the like), the location determining device 130 is controlled by the controller 120 to determine a current location, which is stored at the memory 122 as location data 1607 in association with the time period. As depicted, the location data 1607 comprises a textual identifier “ORD” of a location, indicating that the identifier 407 was received while at an airport (e.g. “ORD” is an airport code). However, in other implementations, the location data 1607 comprises absolute location coordinates and/or relative location coordinates compatible with a type of the location determining device 130 (e.g. the location data 1607 comprises GPS coordinates when the location determining device 130 comprises a GPS device). Furthermore, in other implementations, the location data 1607 is stored as an area and/or a range of location coordinates, for example as geofence data, with a radius of the geofencing being configurable at the application 223.

As further depicted in FIG. 16, device 100 and/or controller 120 is further configured to transmit the identifier 407 during the time period only when the location determining device 130 indicates that a current location comprises the location stored with the identifier 407 (e.g. as indicated by the location data 1607.

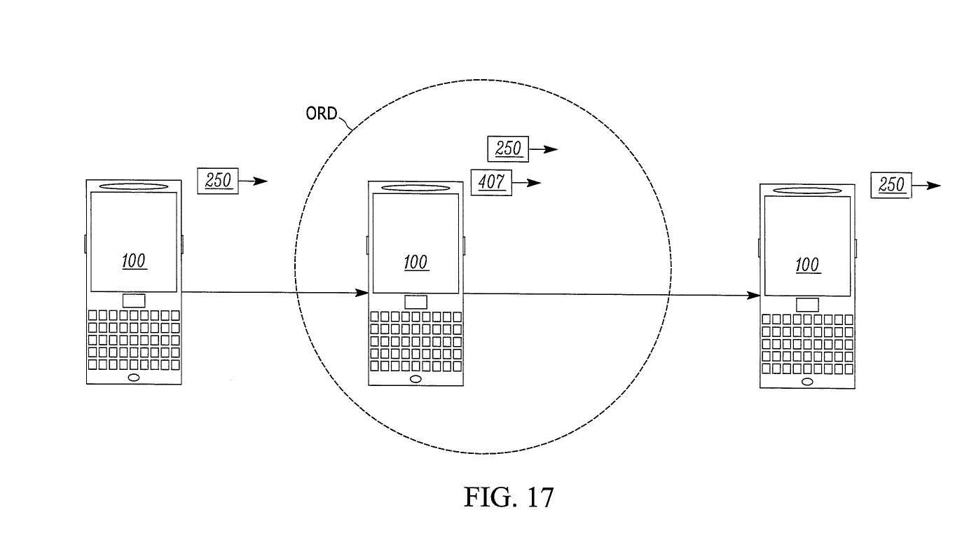

For example, attention is next directed to FIG. 17 which depicts device 100 travelling into and out of a location ORD, similar to the location data 1607. External to the location ORD (as defined at the memory 122 as the location data 1607), the device 100 does not transmit the identifier 407 regardless of whether the time period stored in association with the identifier 407 has expired or not; however, the identifiers 250 (not associated with a time period) are transmitted. However, at the location ORD, and during the time period stored in association with the identifier 407 the device 100 transmits the identifier 407 (and the identifiers 250). In each instance, the current location is determined by the location determining device 130 and compared with the location data 1607 to determine whether or not to transmit the identifier 407.

Hence, in these example implementations, the controller 120 is further configured to: determine a location when the identifier 407 of the new network 409 is received; store the location (e.g. as the location data 1607) at the memory 122 in association with the identifier 407 and the time period; and transmit the identifier 407 of the new network 409 with the existing identifiers 250 of the networks stored at the memory 122, to scan for the new network 409 and the networks, only when the location determining device 130 indicates that a current location comprises the location stored with the identifier 407.

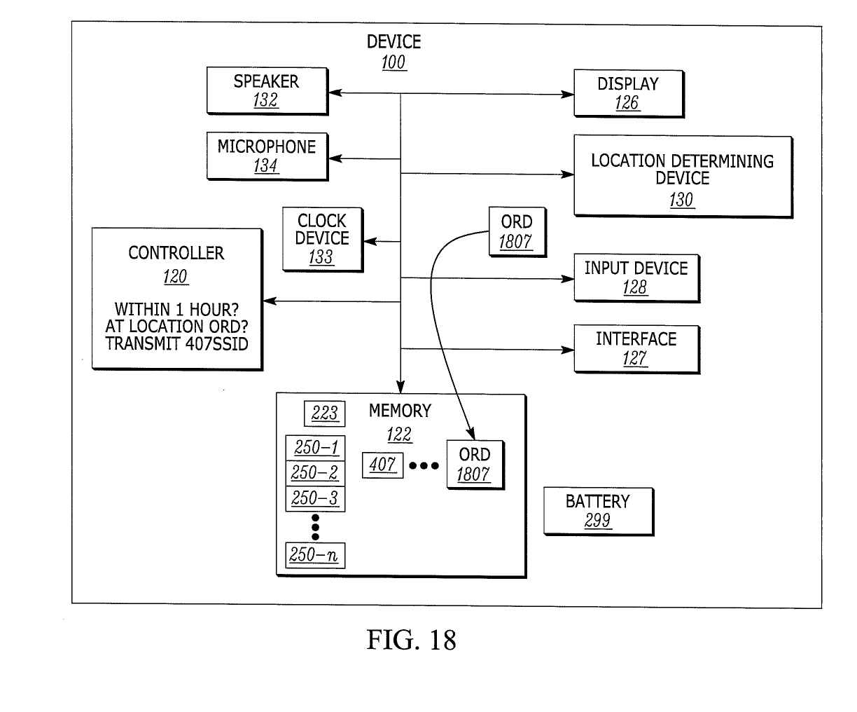

In some implementations where the time period stored in association with the identifier 407 is indicative that the identifier 407 is to be permanently stored (e.g. as in the example of FIG. 9), the controller 120 is further configured to: determine a location when the identifier 407 of the new network 409 is received; when the time period is indicative that the identifier is to be permanently stored, store the identifier 407 at the memory 122 in association with the location and without the time period; and transmit the identifier 407 of the new network with the existing identifiers 250 of the networks stored at the memory 122, to scan for the new network and the networks, only when the location determining device 130 indicates that a current location comprises the location stored with the identifier 407. For example, in with reference to FIG. 18 (substantially similar to FIG. 16, with like elements having like numbers), it is assumed that a time period of “ALWAYS” was selected using the query 551 (e.g. as in the example of FIG. 5), and that example location data 1807, that is similar to location data 1607, is stored in association with the identifier 407, and without a time period. Functionality of device 100 proceeds as described above with respect to FIG. 17, however without regard to a time period.

Furthermore, in some implementations, the time period is saved without a time period based on the location. Such functionality can again be defined using application 223 and/or be configurable. For example, when the location corresponds to an airport (and the like), the query 551 is provided, and when the location is elsewhere (e.g. not corresponding to an airport (and the like)), the query 551 is not provided.

In addition, in some implementations the time periods provided in the query 551 are location dependent; for example, when the location corresponds to an airport, the longest time period provided in the query 551 can be 3 hours, or so, or any other time period that a traveler is likely to spend at an airport.

In some implementations, the device 100 makes use of on-line databases and/or mapping applications and/or on-line mapping applications to determine a business and/or an entity (e.g. an airport etc.) of a current location.

In yet further implementations, the method 300 is modified for implementation independent of whether an identifier of a network has been previously received and/or modified for implementation independent of receiving a time period using an input device.

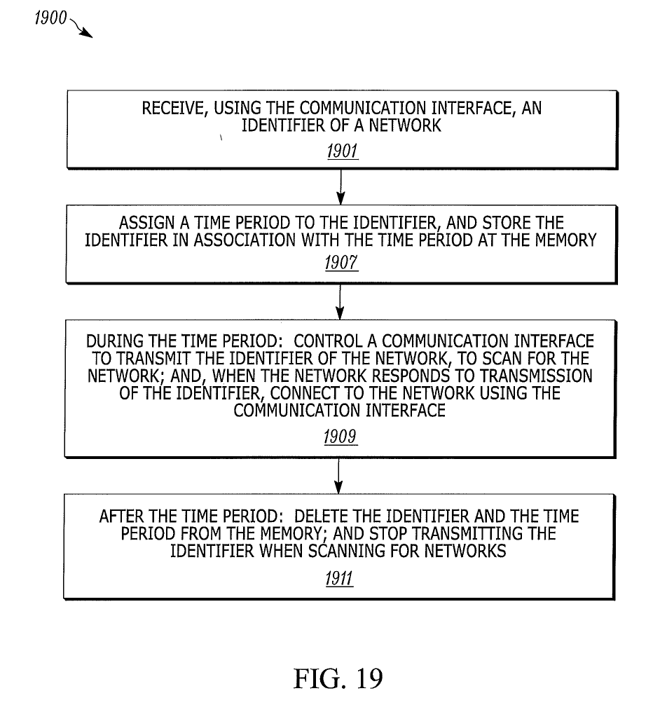

For example, attention is now directed to FIG. 19 which depicts a flowchart representative of an example method 1900 for network profile management, such as the example device 100 of FIG. 2. The example operations of the method 1900 of FIG. 19 correspond to machine readable instructions that are executed by, for example, the device 100 of FIG. 2, and specifically by the controller 120 of the device 100. In the illustrated example, the instructions represented by the blocks of FIG. 19 are stored at the memory 122, for example, as the application 223 and/or a similar application. The example method 1900 of FIG. 19 is one way in which the device 100 may be configured. Furthermore, the following discussion of the example method 1900 of FIG. 19 will lead to a further understanding of the device 100, and its various components. However, it is to be understood that the device 100 and/or the method 1900 may be varied, and need not work exactly as discussed herein in conjunction with each other, and that such variations are within the scope of present implementations.

The example method 1900 of FIG. 19 need not be performed in the exact sequence as shown and likewise various blocks may be performed in parallel rather than in sequence. Accordingly, the elements of the method 1900 are referred to herein as “blocks” rather than “steps.” The example the method 1900 of FIG. 19 may be implemented on variations of the example device 100 of FIG. 2, as well.

Furthermore, numbering of the blocks of the method 1900 correspond to the numbering of the blocks of the method 300, however in a “1900” series, rather than a “300” series, but modified as described below. Hence, for example, the blocks 1901, 1907, 1909, 1911 of the method 1900 respectively correspond to the blocks 301, 307, 309, 311 of the method 300.

At block 1901, the controller 120 receives an identifier of a network.

At block 1907, the controller 120 assigns a time period to the identifier and stores the identifier in association with the time period at the memory 122.

At block 1909, the controller 120, during the time period: controls the communication interface 127 to transmit the identifier of the network to scan for the network; and, when the network responds to transmission of the identifier, connects to the network using the communication interface 127.

At block 1911, the controller 120, after the time period: deletes the identifier and the time period from the memory 122; and stops transmitting the identifier when scanning for networks.

Hence, the method 1900 proceeds in a similar manner to the method 300, however in the method 1900, at the block 1901, in some implementations, the identifier is received in a message and/or from an input device and/or using a GUI (as described above). In addition, a selectable option to connect to the network identified by a received identifier is not necessarily provided (e.g. the method 1900 does not necessarily include blocks analogous to the blocks 302, 303, 305 of the method 300). Furthermore, in the depicted example implementations, at the block 1907, a time period is assigned to a received identifier regardless of whether the identifier was previously stored at the memory 122 or not. For example, in some implementations when one of the identifiers 250 already stored at the memory 122 is received (e.g. a second time) a time period is assigned thereto.

Indeed, in some of these implementations, when the identifier received at the block 1901 is already stored at the memory 122 (e.g. received a second time), and is already stored in association with a time period (e.g. the block 1907 has already been implemented, for example the first time the identifier was received), the time period is replaced with the time period assigned at the block 1907. However, in some examples implementations, the method 1900 ends when the identifier received at the block 1901 is already stored at the memory 122 (e.g. received a second time), and is already stored in association with a time period. Indeed, in example implementations, a mode of operation of the method 1900 is configured using a GUI, a pulldown menu, and the like.

Furthermore, in some implementations of the block 1907, the time period is assigned using a GUI, and the like, as described above. However, in other implementations, a default time period is automatically assigned to the identifier (such as one month) without the use of a query; in some of these implementations, the default time period is changeable and/or configurable using a GUI and the like, and/or a stored time period is changeable and/or configurable using a GUI and the like. In yet further implementations the automatically assigned time period is location dependent; for example, in some of these implementations, identifiers received at locations corresponding to airports are assigned a default time period of a few hours, which can also be changeable and/or configurable using a GUI.

The blocks 1909, 1911 otherwise proceed in a manner similar to respective the blocks 309, 311. For example, blocks 309, 311 are respectively similar to blocks 1909, 1911 when a number of identifiers 250 stored at the memory is “0”.

Described herein is a device and method for network profile management that includes a network save policy for each stored network which defines how long each stored network is to be saved, implemented when a network profile is defined and/or generated for storage at a memory.

In the foregoing specification, specific implementations have been described. However, one of ordinary skill in the art appreciates that various modifications and changes can be made without departing from the scope of the specification as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, XZ, YZ, and the like). Similar logic may be applied for two or more items in any occurrence of “at least one . . . ” and “one or more . . . ” language.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting implementation the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some implementations may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an implementation can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

We claim:

1. A mobile device comprising:
a controller, a display, a memory and a communication interface configured to transmit existing identifiers of networks stored at the memory to scan for the networks, the controller configured to:
receive, using the communication interface, an identifier of a new network not stored at the memory;
control the display to render a first selectable option to store the identifier of the new network at the memory;
when the first selectable option is selected, control the display to render a query for a time period to store the identifier;
in response to the query: receive the time period to store the identifier, and store the identifier in association with the time period at the memory;
during the time period: control the communication interface to transmit the identifier of the new network with the existing identifiers of the networks stored at the memory, to scan for the new network and the networks; and, when the new network responds to transmission of the identifier, connect to the new network using the communication interface; and,
after the time period: delete the identifier and the time period from the memory; and stop transmitting the identifier when scanning for the networks.

2. The mobile device of claim 1, further comprising a location determining device, wherein the controller is further configured to: determine a location when the identifier of the new network is received; store the location at the memory in association with the identifier and the time period; and transmit the identifier of the new network with the existing identifiers of the networks stored at the memory, to scan for the new network and the networks, only when the location determining device indicates that a current location comprises the location stored with the identifier.

3. The mobile device of claim 1, further comprising a location determining device, wherein the controller is further configured to: determine a location when the identifier of the new network is received; when the time period is indicative that the identifier is to be permanently stored, store the identifier at the memory in association with the location and without the time period; and transmit the identifier of the new network with the existing identifiers of the networks stored at the memory, to scan for the new network and the networks, only when the location determining device indicates that a current location comprises the location stored with the identifier.

4. The mobile device of claim 1, wherein each of the new network and the networks comprise WiFi networks, and each of the identifier and the existing identifiers comprise a respective SSID (Service Set Identifier) of each of the WiFi networks, and the controller is further configured to transmit the identifier of the new network with the existing identifiers of the networks stored at the memory by: transmitting the respective SSID of each of the WiFi networks in a respective probe request frame.

5. The mobile device of claim 1, wherein the controller is further configured to, when the time period is indicative that the identifier is to be permanently stored: store the identifier at the memory without the time period; and delete the identifier from the memory only when a delete command for deleting the identifier is received at the controller.

6. The mobile device of claim 1, wherein the controller is further configured to, when one or more of the first selectable option is not selected or the time period is indicative that the identifier is not to be stored: connect to the new network using the using the communication interface; and when the communication interface disconnects from the new network, delete the identifier from the memory.

7. The mobile device of claim 1, wherein the controller is further configured to, when override data is stored at the memory: store the identifier at the memory without the time period; and delete the identifier only when a delete command, for deleting the identifier, is received.

8. The mobile device of claim 1, wherein the controller is further configured to, when a global network save policy is compulsory: store the identifier at the memory without the time period; and delete the identifier only when a delete command, for deleting the identifier, is received.

9. The mobile device of claim 1, wherein the controller is further configured to, in response to one or more of determining that the new network identified by the identifier is a hidden network, and determining that the identifier is part of a hidden profile: control the display to render the first selectable option using one or more of a menu, a pull-down menu and a graphic user interface rendered at the display.

10. A method comprising:
at a device comprising: a controller, a display, a memory and a communication interface configured to transmit existing identifiers of networks stored at the memory to scan for the networks,
receiving, using the communication interface, an identifier of a new network not stored at the memory;
controlling the display to render a first selectable option to store the identifier of the new network at the memory;
when the first selectable option is selected, controlling the display to render a query for a time period to store the identifier;
in response to the query: receiving the time period to store the identifier, and store the identifier in association with the time period at the memory;
during the time period: controlling the communication interface to transmit the identifier of the new network with the existing identifiers of the networks stored at the memory, to scan for the new network and the networks; and, when the new network responds to transmission of the identifier, connect to the new network using the communication interface; and,
after the time period: deleting the identifier and the time period from the memory; and stop transmitting the identifier when scanning for the networks.

11. The method of claim 10, wherein the device further comprises a location determining device, and the method further comprises: determining a location when the identifier of the new network is received; storing the location at the memory in association with the identifier and the time period; and transmitting the identifier of the new network with the existing identifiers of the networks stored at the memory, to scan for the new network and the networks, only when the location determining device indicates that a current location comprises the location stored with the identifier.

12. The method of claim 10, wherein the device further comprises a location determining device, and the method further comprises: determining a location when the identifier of the new network is received; when the time period is indicative that the identifier is to be permanently stored, storing the identifier at the memory in association with the location and without the time period; and transmitting the identifier of the new network with the existing identifiers of the networks stored at the memory, to scan for the new network and the networks, only when the location determining device indicates that a current location comprises the location stored with the identifier.

13. The method of claim 10, wherein each of the new network and the networks comprise WiFi networks, and each of the identifier and the existing identifiers comprise a respective SSID (Service Set Identifier) of each of the WiFi networks, and the method further comprises transmitting the identifier of the new network with the existing identifiers of the networks stored at the memory by: transmitting the respective SSID of each of the WiFi networks in a respective probe request frame.

14. The method of claim 10, further comprising, when the time period is indicative that the identifier is to be permanently stored: storing the identifier at the memory without the time period; and deleting the identifier from the memory only when a delete command for deleting the identifier is received at the controller.

15. The method of claim 10, further comprising, when one or more of the first selectable option is not selected or the time period is indicative that the identifier is not to be stored: connecting to the new network using the using the communication interface; and when the communication interface disconnects from the new network, delete the identifier from the memory.

16. The method of claim 10, further comprising, when override data is stored at the memory: store the identifier at the memory without the time period; and delete the identifier only when a delete command, for deleting the identifier, is received.

17. The method of claim 10, further comprising, when a global network save policy is compulsory: storing the identifier at the memory without the time period; and deleting the identifier only when a delete command, for deleting the identifier, is received.

18. The method of claim 10, further comprising, in response to one or more of determining that the new network identified by the identifier is a hidden network, and determining that the identifier is part of a hidden profile: controlling the display to render the first selectable option using one or more of a menu, a pull-down menu and a graphic user interface rendered at the display.

19. A non-transitory computer-readable medium storing a computer program, wherein execution of the computer program is for:
at a device comprising: a controller, a display, a memory and a communication interface configured to transmit existing identifiers of networks stored at the memory to scan for the networks,
receiving, using the communication interface, an identifier of a new network not stored at the memory;
controlling the display to render a first selectable option to store the identifier of the new network at the memory;
when the first selectable option is selected, controlling the display to render a query for a time period to store the identifier;
in response to the query: receiving the time period to store the identifier, and store the identifier in association with the time period at the memory;
during the time period: controlling the communication interface to transmit the identifier of the new network with the existing identifiers of the networks stored at the memory, to scan for the new network and the networks; and, when the new network responds to transmission of the identifier, connect to the new network using the communication interface; and,
after the time period: deleting the identifier and the time period from the memory; and stop transmitting the identifier when scanning for the networks.
